(19) United States
(12) Patent Application Publication
(10) Pub. No.: US 2002/0068122 A1
(43) Pub. Date: Jun. 6, 2002

(54) Fat free or reduced fat nut

(76) Inventor: Kanaiyalal J. Hathi, Oak Brook, IL (US)

Correspondence Address: Robert L. Marsh, 54 Danada Drive, P.O. Box 4468, Wheaton, IL, 60189-4468, US

(21) Appl. No.: 09/731,296

(22) Filed: Dec. 6, 2000

Related U.S. Application Data
(60) Provisional application No. 60/169,351, filed on Dec. 6, 1999.

(51) Int. Cl. A23L 1/27

(52) U.S. Cl. 426/473; 426/512; 426/518

(57) ABSTRACT

A fat free nut is formed by shelling a quantity of nuts and milling the nuts into a powder to extract the fats and oils. The powder is then combined with a binder and agents to enhance the color and taste. The powder is then inserted into a mold to form the powder into the shape of

The applicant claims priority from his provisional application filed Dec. 6, 1999 and assigned serial number 60/169,351. The present invention relates to a method for manufacturing or reconstructing a fat free or reduced fat peanut.

### BACKGROUND OF THE INVENTION

Peanuts or, for that matter, nuts in general offer numerous nutritional values and are tasty to eat, yet nuts have high contents of fat or oil. Many consumers desire fat free or reduced fat productions and, therefore, it would be desirable to provide a fat free or reduced fat peanut.

### SUMMARY OF THE INVENTION

Briefly, the present invention is embodied in a nut, which may be a peanut or any other type of nut, that is manufactured by first providing a quantity of harvested nuts. If the nuts are in shells, the shells of such nuts are first removed, after which the shelled nuts are passed through a mill for extracting the oil therefrom. Any of a number of milling processes are known and, typically, nuts are crushed in the milling process leaving nut particles from which the oil has been extracted. Thereafter, the nut particles are ground into a fine power and the powder may be passed through a screen to ensure the uniformity thereof.

In accordance with the invention, a mold for forming the shape of the desired nut is then provided. The powder may be combined with a liquid binder to form a slurry and placed in the mold to dry and harden. Water has been found suitable binder. Alternately the powder can be compressed in the mold to form a nut in the desired shape. The nut may be retained by a suitable binder which provides the desired texture or “crunch,” and the compressed nut may be dipped or sprayed to ad coloring or flavor to the surface or by adding salt to reach the taste desired.

### BRIEF DESCRIPTION OF THE DRAWINGS

A better understanding of the present invention will be had after a reading of the following detailed description taken in conjunction with the drawings wherein:

FIG. 1 is a cross sectional view of a peanut and shell of the type currently available on the market;

FIG. 2 is a schematic drawing of the process employed to produce a fat free nut in accordance with the present invention;

FIG. 3 is a fragmentary cross sectional view of a mold employed to manufacture a fat free nut in accordance with the invention; and

FIG. 4 is a schematic drawing of a second embodiment of the process of the present invention.

### DETAILED DESCRIPTION OF THE PREFERRED EMBODIMENT

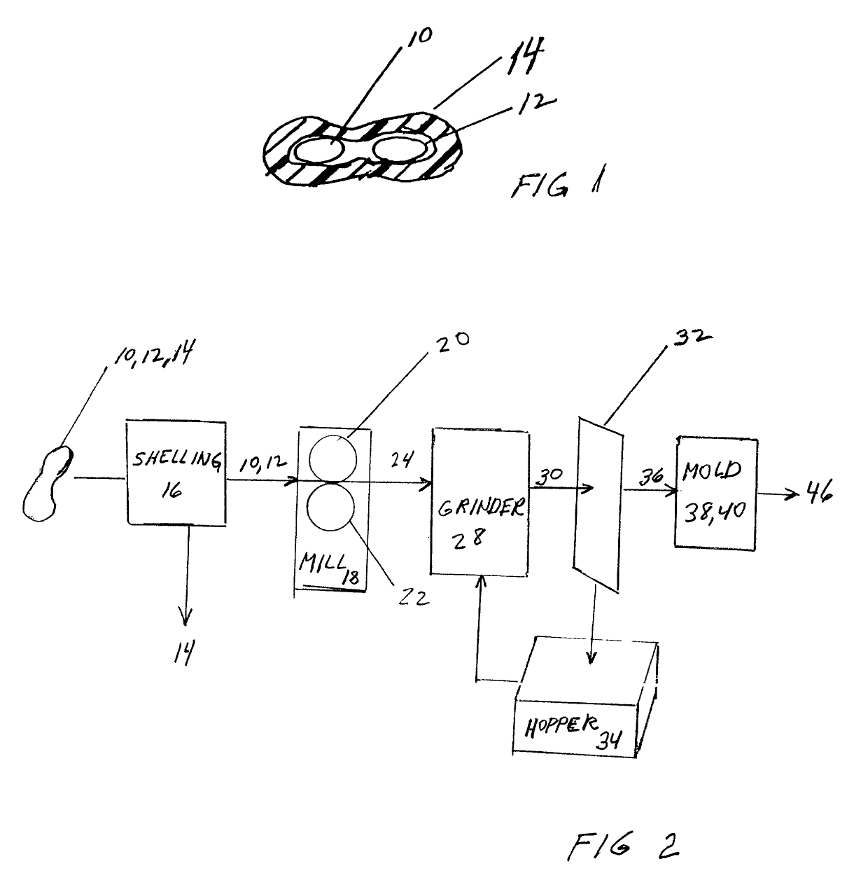

Referring to FIGS. 1 and 2, a pair of peanuts 10, 12 in a common shell 14 are removed from their shell 14 in a shelling process 16 of the type commonly known in the art. The shells 14 are then discarded and the separated nuts 10,12 are then directed through a mill 18 for extracting the oil therefrom. Mills 18 are known in the art and generally include rollers 20, 22 which break the nuts 10, 12 to form nut particles 24 of various sizes. The oil is extracted through a discharge 26 in the mill 18 and the nut particles 24 are then directed to a grinder 28. In the grinder 28, the nut particles are crushed into a fine powder 30. The powered nut particles are then passed through a screen 32 to separate any larger particles therefrom. Particles that fail to pass through the screen 32 are collected in a hopper 34 and recycled through the grinder 28. The product passing through the screen 32 is a fine power 36

Referring to FIGS. 2 and 3, in accordance with the present invention, a mold, having a lower body 38 and an upper portion 40 is provided is compress the powder 36 into the shape of a peanut. As shown, the lower body 38 is configured as a plate with indentations 42 therein, the lower portions of which are shaped to contour of a complete peanut. The upper portion 40 is configured as a roller having space protrusions 44 therein located so as to mate with the indentations 42 of the plate 38 as the plate 38 moves under the roller 40. Although the mold is depicted as a roller and a plate, it should be appreciated that any suitable mold may be used to compress the power 36 into the shape of a finished peanut 46. A binder may be added to the powder to give the finished nut the desired crunch.

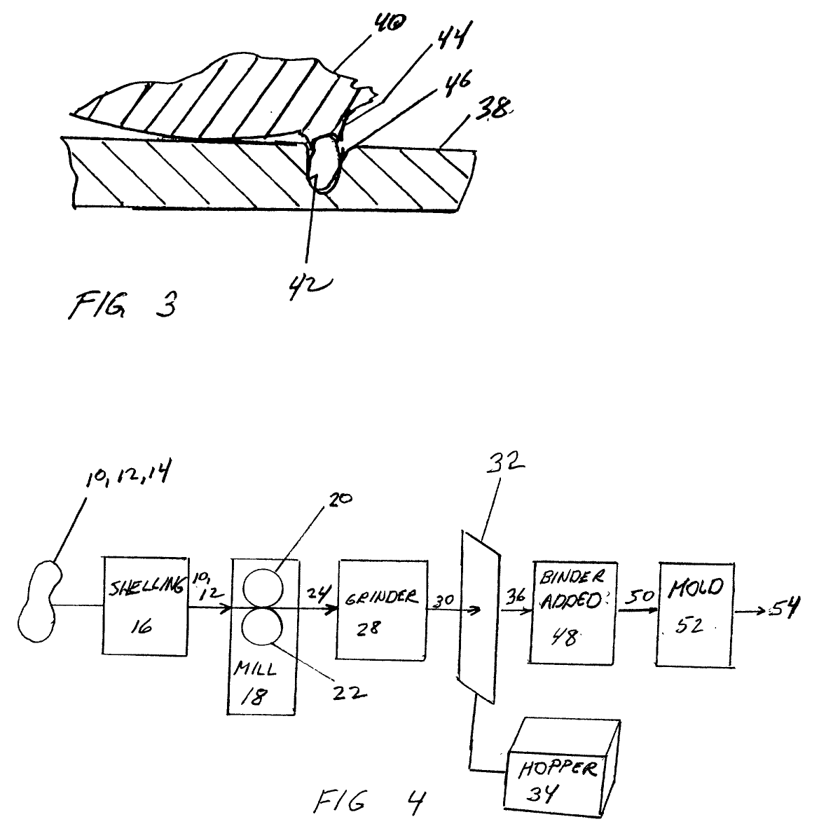

Referring to FIG. 4. alternately the powder 36 may be blended with a liquid binder 48 to form a slurry 50. I have found that water can be added to the powder to form a slurry and will serve as a binder. Coloring and flavoring may be added to the powder to give the completed nut the desired taste and appearance. The slurry is the allowed to dry and harden in the mold without compression. Once the nut 54 has been molded to the desired shape, it can be removed from the mold. 52.

The finished peanut 46, 54 may thereafter be treated to enhance its marketability. For example, coloring may be added to enhance its appearance or salt added to enhance the flavor.

While the present invention is depicted in a single embodiment, it will be appreciated that many modifications and variations can be made without departing from the true spirit and scope of the invention. It is therefore the intent of the appended claims to cover all the modifications and variation that fall within the true spirit and scope of the invention.

What is claimed:

1. The method of forming a reconstituted fat free nut comprising the steps of
obtaining a quantity of nuts milled into a powder,
extracting oil from said milled nuts,
providing a mold for forming a nut shape,
inserting said powder into said mold, and
compressing said powder in said mold to form said reconstituted nut.

2. The method of claim 1 and comprising the further step of adding a flavoring to said powder prior to inserting said powder into said mold.

3. The method of claim 1 and comprising the further step of adding a coloring to said powder prior to inserting said powder into said mold.

4. The method of claim 1 and comprising the further step of coating the surface of said reconstituted nut with one of a coloring and a flavoring.

5. The method of claim 1 and comprising the further step of adding a binder to said powder prior to inserting said powder into said mold.

6. The method of claim 5 wherein said binder is water.

7. The method of forming a reconstituted fat free nut comprising the steps of
obtaining a quantity of nuts milled into a powder,
extracting oil from said milled nuts,
providing a binder,
blending said binder with said milled nuts to form a slurry,
providing a mold for forming a nut shape,
inserting said slurry into said mold, and
allowing said slurry to harden to form said reconstituted nut.

8. The method of claim 7 and comprising the further step of adding a flavoring to said powder prior to inserting said powder into said mold.

9. The method of claim 7 and comprising the further step of adding a coloring to said powder prior to inserting said powder into said mold.

10. The method of claim 7 wherein said binder is water.

11. The method of claim 7 and comprising the further step of coating the surface of said reconstituted nut with one of a coloring and a flavoring.
